(19) United States
(12) Patent Application Publication
(10) Pub. No.: US 2026/0100014 A1
(43) Pub. Date: Apr. 9, 2026

(54) SYSTEM AND METHOD FOR DETECTING CHEMICALS USING HYPERSPECTRAL IMAGING AND AI PROCESSING

(71) Applicant: Fieldstone Bio, Inc., Andover, MA (US)

(72) Inventors: Patrick Stone, North Andover, MA (US); Brandon Fields, Melrose, MA (US); Cameron McKnight, Gainesville, VA (US)

(21) Appl. No.: 19/350,648

(22) Filed: Oct. 6, 2025

Related U.S. Application Data
(60) Provisional application No. 63/703,881, filed on Oct. 4, 2024.

(51) Int. Cl. G06V 10/143; G06V 10/774; G06V 20/69

(52) U.S. Cl. CPC G06V 10/143; G06V 10/774; G06V 20/693; G06V 20/698

(57) ABSTRACT

Systems and methods are disclosed that use microbes as active sensors to make microscopic measurements across surfaces, such as large geographical surfaces. The methodology can image large physical areas with high resolution hyperspectral data, create a dataset that can be analyzed to develop an image analysis model, and then leverage hyperspectral images to determine the presence of materials (chemicals, pathogens, minerals, etc.) of interest. The systems and methods enable a user to identify the target within hyperspectral data, without the need to utilize microbes to measure areas beyond their initial use as labeled training data.

### TECHNICAL FIELD

The subject matter described herein relates to detection of chemicals, mineral, or pathogens using hyperspectral imaging and utilizing an artificial intelligence (AI) model that is developed using microbes as active sensors.

### BACKGROUND

Hyperspectral imaging provides a unique way of detecting chemicals or pathogens on surfaces of soils, structures, processing facilities, liquids, or living things (plants, skin, etc). Hyperspectral imaging data can be represented as a datacube of hyperspectral data (or “hypercube”), with each layer of the datacube representing a different narrow band of color or wavelengths of light. A datacube is a three dimensional representation of data that is optimized for fast and efficient processing and analysis. As an example, a standard camera can take a picture with three color bands, but a hyperspectral camera's image can have hundreds of color bands. Each pixel of a hypercube represents a point in space and is associated with data representing the intensity of each color band or the spectrum of light the camera was imaging at that spatial point.

A hyperspectral hypercube can represent an incredibly complex dataset collected over a geographic spatial area and can be increasingly large and complex when applied over very large surface areas, such as a field or farm. For example, if each pixel represents a square centimeter, then an image of a single acre would represent approximately 40,000,000 pixels, each of which may be associated with kilobytes of spectral data. Further, obtaining ground truth-or in other words associating every pixel with its true constituents—is both extremely expensive and extremely difficult. Presently, processing the data of hyperspectral hypercube artificial intelligence algorithms has been limited by the training datasets and annotations needed to inform models and algorithms.

There are many challenges with hyperspectral data classification, (i.e., a form of correlation or pattern recognition), including spectral-spatial complexity, interpretability, and a lack of labeled training data. For example, regarding spectral-spatial complexity, traditional image classifiers cannot be used as spectral-spatial patterns in hyperspectral images. Another issue is finding correlations between hyperspectral parameters and the concentration of the chemical, mineral, or pathogen of interest. Conventional image classification methods are not, nor can be, fully understood; thereby, raising questions or doubt as to the validity of the data being interpreted. Further, hyperspectral data related to chemicals, minerals or pathogen is sensitive to environmental and/or atmospheric conditions, which requires an adaptive or dynamic analysis process for the image classifiers to be trustworthy.

Furthermore, conventional solutions cannot detect rare events/anomalies accurately. Fine-tuning the hyperparameters of a hyperspectral image analysis model, such as the learning rate, batch size, epochs, etc. to be optimal for normal procedures, variabilities, and abnormalities, remains a challenge in modern day. Hyperspectral datasets are limited in nature due to their cost and complexity, and lack of labeled training data.

Accordingly, what is needed is a system and method to overcome the challenges associated with training and classifying complex hyperspectral data, particularly as related to hyperspectral imaging of geographic spatial areas.

### SUMMARY

To overcome the challenges associated with complex data and limited training datasets as described above, this document describes systems and methods that use microbes as active sensors to make microscopic measurements across surfaces, such as large geographical surfaces. This methodology has the potential to image large physical areas with high resolution hyperspectral data, create a dataset that can be analyzed to develop an image analysis model, and then leverage hyperspectral images to determine the presence of materials (chemicals, pathogens, minerals, etc.) of interest. The systems and methods enable a user to identify the target within hyperspectral data, without the need to utilize microbes to measure areas beyond their initial use as labeled training data.

In some preferred implementations, a system and method create a spatial map with microscopic measurements at scales that are useful to the application, such as, measuring the soil surface nutrient content with fine resolution across entire farms, or measuring/detecting for known pathogens on farms or processing facilities, for example. Once a map is created showing where the target (a specific chemical, type of cell, pathogen, or other microscopic living or non-living detectable item, for example) is located, this data can then be used as a reference to train a custom artificial intelligence image analysis model designed to input the innate high dimensionality and complex nature of the hypercube and produce a meaningful output representing a measurement of detection of the target.

The effect of this approach enables identification of the target (chemical, pathogen, mineral, etc.) within hyperspectral data, without the need to utilize microbes to measure areas beyond their initial use as labeled training data.

In some aspects, a method includes deploying a plurality of microbial biosensors across a selected target area, the microbial biosensors being configured to measure a target chemical, pathogen, and/or cell stimuli. The method further includes acquiring a high-resolution hyperspectral image of the target area, and measuring the microbial biosensors response within the target area for the target chemical/pathogen/cell stimuli to generate biosensor data that is stored in a hypercube data structure. The method further includes applying the biosensor data from the hypercube data structure as a reference to train an artificial intelligence model, using the original hyperspectral image and the biosensor data as training data, and executing an algorithm configured to analyze the hypercube data structure to produce an output representing a measurement of detection of the target chemical, pathogen, and/or cell stimuli.

In other aspects, a system includes a plurality of microbial biosensors configured to be deployed across a selected area, the microbial biosensors each further configured to measure a target chemical, pathogen, and/or cell stimuli, and to acquire a high-resolution hyperspectral image of the target area. In some aspects, the system further includes one or more processors configured to measure the microbial biosensors response within the target area for the target chemical/pathogen/cell stimuli to generate biosensor data, the one or more processors further configured to store the biosensor data in a data structure such as a hypercube, and to apply the biosensor data from the data structure as a reference to train an artificial intelligence model using the original hyperspectral image and the biosensor data as training data, the one or more processors being further configured to analyze the biosensor data in the hypercube data structure based on the artificial intelligence model to produce an output representing a measurement of detection of the target chemical, pathogen, and/or cell stimuli. In yet further aspects, a system can include a spatial-spectral projector to analyze the hypercube data structure and to generate an image representation of the target chemical, pathogen, and/or cell stimuli for display on a user interface.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to the method for deploying microbial biosensors and obtain training data to train analysis algorithms, it should be readily understood that such features are not intended to be limited but can apply to other applications and environmental measurements in agriculture, environmental services, mining, healthcare, and national security industries. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates the use of encoded microbes for detecting one or more of a target chemical/pathogen/cell stimuli;

FIG. 2 shows a diagram illustrating aspects of a system showing features consistent with implementations of the current subject matter; and

FIG. 3 shows a process flow diagram illustrating aspects of a method having one or more features consistent with implementations of the current subject matter;

When practical, similar reference numbers denote similar structures, features, or elements.

### DETAILED DESCRIPTION

Microbes inhabit nearly every corner of our planet and have evolved molecular mechanisms to sense chemicals or stimuli in their environments. In accordance with implementations described herein, microbes are engineered to carry sensors (encoded in their DNA) that respond to a variety of signals in a geographic area. For example, U.S. Patent Publication No 2023/0183677, the contents of which are incorporated by reference herein for all purposes, describes the use of engineered microbes to enable environmental insights.

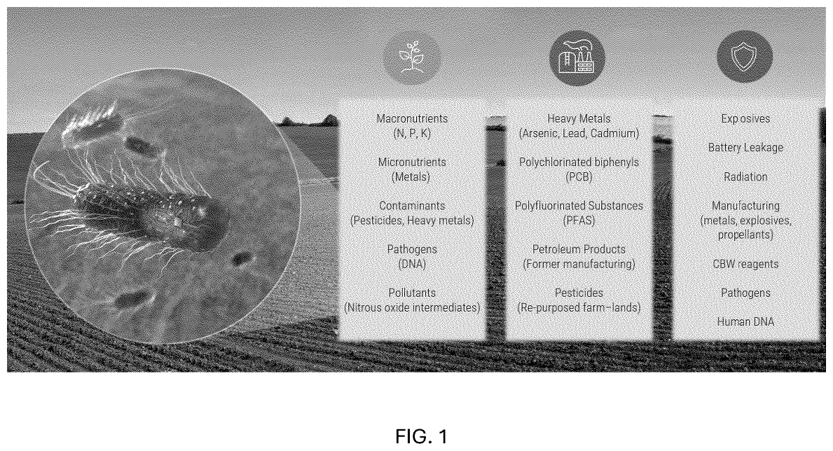

In some implementations, and as illustrated in FIG. 1, the microbes are encoded to detect specific organic or inorganic matter, such as, without limitation, one or more of macronutrients, micronutrients, contaminants, pathogens, and pollutants.

In accordance with the systems and methods described herein, unique spectral reporters within the microbes are used to produce a signal that a hyperspectral camera can use to detect—essentially creating a communications path from the sensing microbe to the hyperspectral camera. These biosensors can be engineered and used to measure microscopic amounts of chemicals or cell stimuli in their immediate environment. When used at large scales with billions of cells, the disclosed systems and methods can produce high resolution measurements of microscopic chemicals in a hyperspectral image, and which can be interpreted, analyzed, and explained in detail.

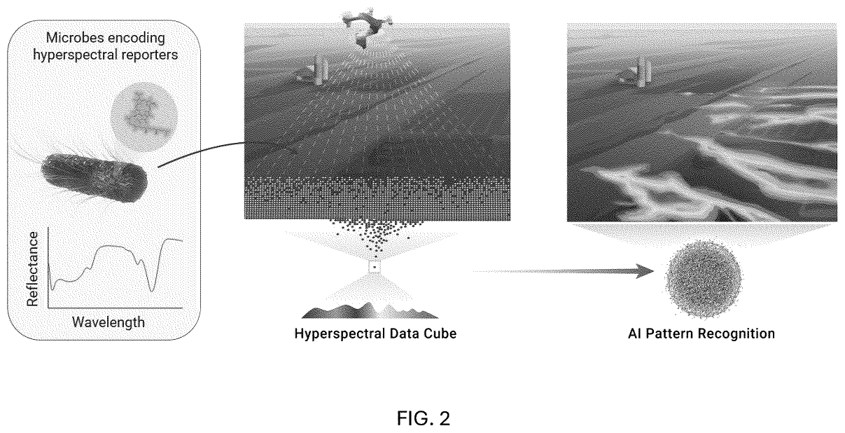

To overcome the challenges associated with complex data and limited training datasets, as shown in FIG. 2, exemplary implementations of the present invention use microbes as active sensors to make microscopic measurements across surfaces with the potential to image large physical areas with high resolution hyperspectral data. This process creates a spatial map with microscopic measurements at scales that are useful to the application, which can use artificial intelligence pattern recognition to determine an aspect of the surface. As an example, measuring the soil surface nutrient content with fine resolution across entire farms or measuring/detecting for known pathogens on farms or in processing facilities. Once a map is created showing where the target (a specific chemical, type of cell, pathogen, or other microscopic living or non-living detectable item) is located, this data is used as a reference to train a custom artificial intelligence image analysis model designed to input the innate high dimensionality and complex nature of the data structure, such as a hypercube described herein, and produce a meaningful output representing a measurement of detection of the target. In some implementations, once the AI model is trained, it can then use hyperspectral data to detect the target material, even without using the microbes.

Accordingly, the system and method disclosed herein are configured for creating labeled training data. The system, and method executed thereby, includes an artificial intelligence model architecture that has both online learning and transfer learning capabilities that are configured to update the hyperspectral image analysis continuously. The effect of this approach enables a user to identify the target (i.e., chemical, pathogen, or the like) within hyperspectral data, without the need to utilize microbes to measure areas beyond their initial use as labeled training data.

With a large enough labeled dataset, provided by microbial measurements at scale, an artificial intelligence model is used for hyperspectral image analysis, and trained from the labeled microbe dataset, to measure and identify the location and intensity of a target chemical concentration using hyperspectral cameras. This capability is trained off the microbes to measure and identify the location and intensity of a target using hyperspectral cameras.

In some preferred exemplary implementations, a method, executed by a system described herein, includes the following steps. At 302, a high-resolution hyperspectral image of the target area is taken, captured, or otherwise acquired. The high-resolution hyperspectral image can be taken by a digital camera, and the image can be stored locally or transmitted over a network, which can include one or more of a wireless or wired data communication link, for remote storage.

At 304 microbial biosensors are deployed or applied across the target area, where the microbial biosensors are configured to measure a target chemical/pathogen/cell stimuli. In preferred implementations, the system needs to wait for the biosensors to complete their sensing and respond at 306. In alternative implementations, the system can process the sensing in near real-time as the sensing is executed. At 308, the biosensors'response is measured within the target area for the specific chemical. In some implementations, the biosensor response is measured using a hyperspectral camera. In particular exemplary implementations, the hyperspectral imaging need only be done once: the microbes are applied, the hyperspectral image taken (which includes the signature output of the microbes indicating the target material), and the AI-based correlation performed between the aspects of the spectrum that are not output by the microbes to the signature output by the microbes. Once the correlation model is obtained, the target of interest can be obtained using a hyperspectral camera, without needing to use the microbes.

At 310, this data is applied to an artificial intelligence model as training data and can include the original hyperspectral image and the biosensor data. At 312, the processing is conducted over a large number of areas with different parameters and fine-tuned accordingly. The fine-tuning can include modification of the model, such as adjusting weights of parameters, or accounting for intensities of sensing returns of the biosensors based on, without limitation, environmental factors such as weather, temperature, pressure, precipitation, or the like. At 314, the algorithm and model are applied to new sets of hyperspectral data to automatically identify where the target chemical is across target imaged area, leveraging online and transfer learning model.

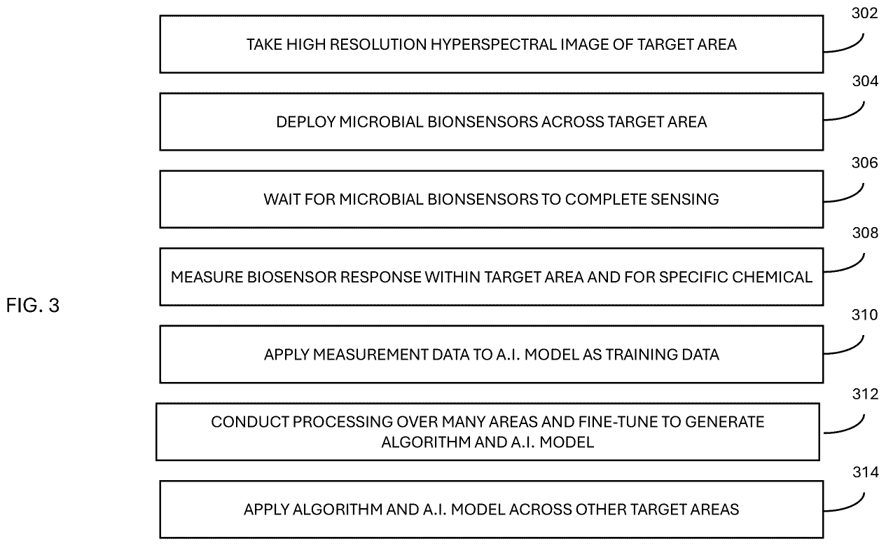

With reference again to FIG. 3, utilizing hyperspectral data (302) provides a unique way of detecting chemicals or pathogens on surfaces. Microbial biosensors are deployed across a target area at 304, which are configured to sense a target chemical, pathogen, and/or cell stimuli. A hyperspectral hypercube, derived from a standardized mathematical denotation, represents a complex dataset collected over a large area. This process creates a spatial map with microscopic measurements at scales that are useful to the presently described systems and methods such as measuring nutrients in soil across entire farms or measuring for known pathogens on farms or in processing facilities.

Once a map is created showing where the target is located, this data can be used as a reference to train a custom hyperspectral image analysis model to address the innate high dimensionality and complex nature of the hyperspectral hypercube. There are many challenges with hyperspectral data classification including spectral-spatial complexity, interpretability, and a lack of labeled training data. To address the problem set and the challenges outlined above, the present systems and methods employ a unique process for creating labeled training data, and an artificial intelligence model architecture that has both online learning and transfer learning capabilities to update our hyperspectral image analysis, continuously. The effect of this novel, state of the art approach allows us to identify the target (chemical, pathogen, mineral, etc.) within hyperspectral data, without the need to measure the area with microbes beyond their use as labeled training data.

With a large enough labeled dataset, provided by microbial measurements at scale, a system and method can use an artificial intelligence model for hyperspectral image analysis, trained using a labeled microbe dataset, to measure and identify the location and intensity of a target chemical concentration using hyperspectral cameras. This capability is trained off of microbes to measure and identify the location and intensity of a target chemical or other biological material using hyperspectral cameras. The overarching process is described below:

In preferred implementations, our AI hyperspectral image analysis system includes a spatial-spectral projector and a modular header. The spatial-spectral projector is simply configured to capture and utilize spatial and spectral information from the hyperspectral image, simultaneously, and then feed into the architecture of the AI image analysis model. By this setup, the AI image analysis model can accommodate for variations and abnormalities in spatial and spectral data captured, contributing to a more robust model. Various methods exist to fully exploit these models and their capabilities, including transfer learning, in which a model trained for one task can be leveraged for related tasks, and continuous learning, in which the model continuously updates its parameters based on new observations.

As further depicted in FIG. 3, a flow process is as follows: A user collects, labels, and then trains the AI hyperspectral image analysis system utilizing one or more datasets and image analysis training algorithms to obtain a pre-trained model, of what is specifically of interest (chemical, pathogen, or mineral). This pre-trained model is then saved for the user to leverage at any time. Once a user has a hyperspectral image of what they would like classified for a specific chemical, pathogen, or mineral, they input the image into the AI hyperspectral image analysis system. The hyperspectral image input is then fed through the AI model architecture to output to the user what was detected in the hyperspectral image input. This output is presented back to the user as an red, green, blue (RGB) image of the previous hyperspectral image input, highlighted in various colors with what is detected and a confidence interval to coincide with this analysis. The confidence interval informs the user with a percentage calculation of how confident the AI model thinks that specific chemical, pathogen, or mineral of interest, is in the input hyperspectral image. An AI hyperspectral image analysis model can be trained to find more than one specific chemical, pathogen, or mineral of interest. These specific sources are referred to as class predictions, as a user would have to define these classes in the initial labeling and training of the AI hyperspectral image analysis model.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED or OLED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C,” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
deploying a plurality of microbial biosensors across a selected target area, the microbial biosensors being configured to measure a target chemical, pathogen, and/or cell stimuli;
acquiring a high-resolution hyperspectral image of the target area;
measuring the microbial biosensors response within the target area for the target chemical/pathogen/cell stimuli to generate biosensor data that is stored in a data structure;
applying the biosensor data from the data structure as a reference to train an artificial intelligence model, using the original hyperspectral image and the biosensor data as training data; and
executing an algorithm configured to analyze the data structure to produce an output representing a measurement of detection of the target chemical, pathogen, and/or cell stimuli.

2. The method in accordance with claim 1, wherein the data structure is a datacube representing the biosensor data from the hyperspectral image.

3. The method in accordance with claim 1, further comprising:
applying the deploy, measure and apply steps over a plurality of areas with different parameters; and
applying the analysis algorithm and model to new sets of hyperspectral data to automatically identify the target chemical/pathogen/cell stimuli across a new target area.

4. The method in accordance with claim 1, wherein the biosensor data is captured by one or more hyperspectral cameras.

5. The method in accordance with claim 4, further comprising generating a spatial map with microscopic measurements by the one or more hyperspectral cameras of the biosensor data.

6. The method in accordance with claim 2, wherein the datacube is formatted to be analyzed using a spatial-spectral projector to generate an image representation of the target chemical, pathogen, and/or cell stimuli for display on a user interface.

7. A system comprising
a plurality of microbial biosensors configured to be deployed across a selected area, the microbial biosensors each further configured to measure a target chemical, pathogen, and/or cell stimuli, and to acquire a high-resolution hyperspectral image of the target area; and
one or more processors configured to measure the microbial biosensors response within the target area for the target chemical/pathogen/cell stimuli to generate biosensor data, the one or more processors further configured to store the biosensor data in a data structure, and to apply the biosensor data from the data structure as a reference to train an artificial intelligence model using the original hyperspectral image and the biosensor data as training data, the one or more processors being further configured to analyze the biosensor data in the data structure based on the artificial intelligence model to produce an output representing a measurement of detection of the target chemical, pathogen, and/or cell stimuli.

8. The method in accordance with claim 1, wherein the data structure is a datacube representing the biosensor data from the hyperspectral image.

9. The system in accordance with claim 7, wherein the one or more processors are further configured to:
apply the deploy, measure and apply steps over a plurality of areas with different parameters; and
apply the analysis algorithm and model to new sets of hyperspectral data to automatically identify the target chemical/pathogen/cell stimuli across a new target area.

10. The system in accordance with claim 7, further comprising one or more hyperspectral cameras configured to capture the biosensor data.

11. The system in accordance with claim 10, wherein the one or more processors are further configured to generate a spatial map with microscopic measurements by the one or more hyperspectral cameras of the biosensor data.

12. The system in accordance with claim 8, further comprising a spatial-spectral projector to analyze the datacube and to generate an image representation of the target chemical, pathogen, and/or cell stimuli for display on a user interface.
